(19) United States
(12) Patent Application Publication
(10) Pub. No.: US 2013/0004644 A1
(43) Pub. Date: Jan. 3, 2013

(54) Method for manufacturing a whole milk cheese

(76) Inventor: John H. Ernster, SR., Palos Verdes Estates, CA (US)

(21) Appl. No.: 13/135,264

(22) Filed: Jul. 1, 2011

(51) Int. Cl. A23C 19/00

(52) U.S. Cl. 426/582

(57) ABSTRACT

A new cheese and its unique method for manufacturing, wherein dry whole milk is the primary ingredient. In the process, and when the milk reaches a ph of approximately 6, salt and tri-potassium phosphate are added to the mixture. The dry mixture can then be shipped or stored until further processing. Then, heated water is added to the mixture, and mixed within a steam jacket, until such time as it forms a thick homogenous mass, and it is then packaged as a whole milk cheese product.

### FIELD OF THE INVENTION

This invention relates to food processing, and pertains to a new cheese and unique method for its manufacture. The concept of this invention is to manufacture a whole milk cheese.

### BACKGROUND OF THE INVENTION

The manufacture of cheese has been around for ages. The concept of coagulating milk, and separating its curd, from the whey and consolidating the curd in a molding process, into either a soft cheese, or subjected to pressure for producing hard cheese, and then ripened for use as a food has been available for endless generations.

In fact, the inventor identified herein previously obtained patent protection upon a cheese manufacturing method, as identified in U.S. Pat. No. 5,429,829. In the patent, the cheese manufacturing process included separating milk into skim milk and cream fractions, coagulating the skim milk fraction at a moderately high temperature, to produce curds, and combining the curds with the cream fraction. In that process, the curds were preferable separated from the whey, and dehydrated prior to being combined with the cream. The fat content of the cream therein was increased before it was mixed with the curds. Then, cultured milk was added to the cream-curd mixture, to regulate the moisture content of the resulting processed cheese.

Many other related processes had previously been patented, by others, but generally involved the concept of the producing a curd, from the milk and separating the whey, in order to produce some segment of a cheese product.

### SUMMARY OF THE INVENTION

The concept of this current invention is to provide a different method for the manufacture of cheese, and generally involves the production of cheese in the category of what is herein being called a whole milk cheese. The concept of this current invention, and its method of application, is to process more of the whole milk protein into the cheese product, in order to enhance its nutritional quality and taste, and to even function as a better food balanced cheese for human consumption.

Milk protein is usually 82% casein and 18% lactalbumin. When the milk reaches a ph of 4.8, due to the cultures that create lactic acid and lower the isoelectric level, the casein fraction forms a coagulum, and usually separates from the solution. The still soluble milk fractions are drawn off as the whey. The whey contains most of the 88% of the water in milk, plus it includes the largest nutritional fraction of lactose or carbohydrate of milk. The 18% lactalbumin fraction of milk protein is also in the whey, with considerable lactic acid adding to the milk minerals. The process of managing to separate lactalbumin is very expensive, but it can be done by microfiltration techniques. This is a very valuable portion of the milk protein, and is a significant part of the business of manufacturing cheese by the large cheese factories. Lactalbumin is of very high quality, and rapidly assimilates with the body, and is much used in muscle and body building health food supplements, as previous explained, both substantially lacking in normal cheese production.

It has been found that the only way to capture all of the components of milk is to dry the entire milk product. The process is to evaporate the milk to around 40% to 50% solids, and then dry that as a whole milk powder. Those remaining ingredients have a high nutritionally value in their usage as a food ingredient, and can add significantly to the quality and taste of any cheese that is manufactured from it. Hence, the concept of this invention is to form a better nutritional cheese product through the complete use of milk nutrients, by making cheese from dry whole milk powder. It is believed that this is significant to any purchaser, user, or consumer, because it distinguishes a new and complete nutritional level for manufactured cheese.

Hence, the principal object of this invention is to provide a cheese, made from a grade A type of dry whole milk.

Another object of this invention is to provide a new method for making a new type of cheese product, mainly from dry whole milk.

Still another object of this invention is to provide a useful method of making a new cheese defined from ingredients generally in category of dry milk powder, which produces a whole milk cheese.

However a skim milk cheese can be made by this invention with very low fat levels 2-5% of the resultant skim milk cheese which is a result of left over combined fat from separating the fat from whole milk in the manufacture of non fat dry milk. (see formula 2 and analysis) Further an imitation cheese can also be made by simply adding soy oil to the ingredients. (see formula 3 and analysis) It is also possible to use non fat dry milk by the simple expedient of adding butter fat to the formula to come up with simple method of manufacturing a cheese with a wide range of fat in the resultant cheese.

Another object of this invention is to make a more nutritionally balanced cheese which is less expensive to manufacture and process, and can be made anywhere without any high investment in equipment, or manufacturing facilities, as is normally required in the processing of present day cheese products, and their factories for such manufacture. Without the significant problem of utilizing or disposal of high biological oxygen demand whey fraction.

Another object of this invention is to provide whole milk cheese product from the process as defined herein (plus other options as above).

Cheese can be made by the addition of dry whole milk powder but in most all cases, it is recombined with water and used as a substitute for normal liquid milk or added to normal liquid milk to increase solids thereby increasing the cheese yield. It is very often used in this manner in Mexico where liquid cows milk is often in short supply and thereby extending the supply of liquid milk or normal liquid milk for cheese manufacture. Most of all of this rehydration is with low fat dry milk and fat is added. Usually some type of vegetable fat is used as a monetary savings particularly in Mexico while it is in most prevalent use. In most cases the product is sold as human consumption liquid milk. The amount of non fat dry milk is much cheaper and is 98% of the total dry milk manufacture in the USA. That is not the case in this invention only enough water is added to make a semi plastic product which duplicates the structural organolyptic projects of cheese.

These and other objects may become more apparent to those skilled in the art upon review of the summary of the invention as provided herein, and upon undertaking a study of the description of its preferred embodiment, in view of the drawings.

### DESCRIPTION OF THE DRAWINGS

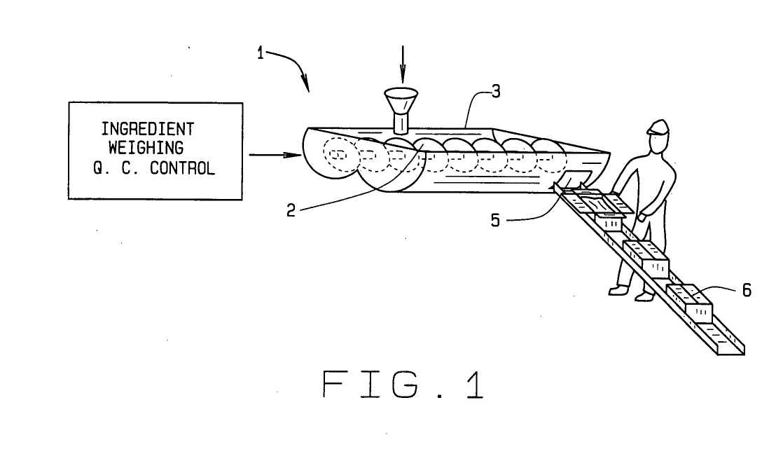

In referring to the drawings, FIG. 1 is a schematic view of the whole milk cheese processing equipment, showing the various components utilized in the process of manufacturing of a whole milk cheese product.

### DESCRIPTION OF THE PREFERRED EMBODIMENT

The concept of this invention is to provide a new cheese and unique method for its manufacture. The new cheese is called whole milk cheese. In the manufacture of most recognized cheeses only a portion of the nutritional and minerals in milk are captured and utilized in the cheese. This varies with the cheese type but almost universally the (lactalbumin) protein fraction or milk protein in not in cheese. Milk protein is usually 82% casein and 18% lactalbumin. When the milk reaches a pH of 4.8 due to cultures that create lactic acid and lower the isoelectric level the casein fraction forms a coagulum and falls from solution. The still soluble milk fractions are drawn off as whey. The whey contains most of the 88% water in milk plus the largest nutritional fraction lactose or carbohydrate of milk. The 18% lactalbumin fraction of milk protein is also in the whey with considerable lactic acid adding to milk minerals. The process of managing to separate lactalbumin is very expensive and really only possible relatively recently by microfiltration techniques. This is a valuable portion of milk protein and is now a big business for cheese factories. Lactalbumin is of very high quality and is rapidly assimilated by the human body and much used in muscle and bodybuilding health food supplements.

The only way to capture all the components of milk is to dry the entire milk. The process is to evaporate the milk 40-50 percent solids and then spray or roller dry it as whole milk powder.

As one can see from the nutritional information provided, you capture essentially everything.

Milk varies in composition from the breed of cow, the feed consumed, and the lactating cycle. This is not a large difference and the composition of milk can be considered as the USDA defines milk, dry, whole (See appendix A, which is incorporated herein by reference).

### Grade A Dry Whole Milk

### Nutrient Information

The nutrients found in 100 grams of products are as follows:

| Protein (Nx6. 38) | 26.32 | g |
|---|---|---|
| Total Carbohydrates | 38 | g |
| Dietary Fibers | 0 | g |
| Lactose | 36 | g |
| Fat. Total | 26.71 | g |
| Water | 2347 g Maximum | |
| Ash Minerals | 6.08 | g |
| Calories | 496 | K cal |

### Minerals

| | | |
|---|---|---|
| Calcium | 912 | mg |
| Iron | 0.47 | mg |
| Magnesium | 85 | mg |
| Phosphorus | 776 | mg |
| Potassium | 1330 | mg |
| Sodium | 371 | mg |
| Zinc | 3.34 | mg |

### Lipids Fatty Acids

| | | |
|---|---|---|
| Saturated Fat | 16.742 | g |
| Monounsaturated, total | 7.924 | g |
| Polyunsaturated, total | 0.665 | g |
| Cholesterol | 97 | mg |
| Calories from Fat | 6.5 | K cal |
| Trans Fatty Acids | 0 | mg |

Therefore the best and most complete use of milk nutrients is to make cheese from dry whole milk powder. The name whole milk cheese is significant to a purchaser or user because it distinguishes a new complete nutritional level of cheese.

The invention of whole milk cheese is made from grade A dry whole milk, and the inventor has have no knowledge of cheese made by this method heretofore. The production method is quite simple. The uniqueness of the formula allows the ease of production.

All nutritional ingredients are from dry whole milk which was pasteurized when taken into the processing plant. Grade A dry whole milk has a high microbiological standard. The other ingredients are flavor intensifiers or favors that are sterile. Salt, Tri Potassium phosphate, or similar organic metallic salts and chymosin are all used as cheese flavors.

Pounds

Formula:

| | |
|---|---|
| Grade A Dry Whole Milk | 550 |

Flavor Components:

| | |
|---|---|
| Salt | 17 |
| Tri Potassium Phosphate | 10 |
| Chymosin | 3 |
| Boiling Water | 250 +/− 50 pounds depending upon |
| | the moisture content desired |
| | for the finish cheese product. |

### Example 1

### Whole Milk Cheese

| | 1000 lbs. |
|---|---|
| Dry Whole Milk | 591.5 |
| Salt | 18.2 |
| Tri-Pot. Phosphate | 10.7 |
| 750 XLF | 3.2 |
| Boiling Water | 376.5 |
| Moisture 38% | 1000.1 |

| | | | Method | Test |
|---|---|---|---|---|
| Analyte | Results | Units | Reference | Date Loc. |
| Ash | 6.51 | % | AOAC 935.42 | May 20, 2010 |
| Calories by | 336 | Cal/100 g | Atwater | May 24, 2010 |
| Calculation | | | Factors | |
| Carbohydrates | 17.30 | % | Calculation | May 24, 2010 |
| Calculation | | | | |
| Fat Mojo, Acid | 22.96 | % | AOAC 926.08 | May 24, 2010 |
| Hydrolysis | | | | |
| Moisture- | 38.23 | % | AOAC 926.08 | May 24, 2010 |
| Vacuum Oven | | | | |
| Protein-kjeldahl | | | AOAC 920.123 | May 24, 2010 |
| Protein Factor | 6.38 | — | | |
| As Received | 15.00 | % | | |

These ingredients are weighed out and placed in a twin screw mixer, or the like, and dry mixed for 2 minutes, and the 3 pounds of liquid chymosin are mixed in 30 pounds of ambient temperature water, and have poured in the dry ingredients and mixed for 1 minute, and 220 pounds of boiling water is added to the mixer in a couple of minutes. Cool water also makes the same cheese, but for microbiological reason inventor prefers boiling water. The now completed cheese turns into a thick homogeneous mass and is pumped out in 40 pound cardboard boxes within a plastic inner liner. It is then allowed to cool or put in a 35° F. cooler.

The above production method and the readily available dry ingredients make it possible to produce a cheese that has a pleasing and very mild cheese flavor.

This presents a preferred taste of cheese as a mild cheddar or jack flavor. This product fits it to a “T” naturally.

Whole milk cheese is a natural nutritional cheese contains 30 percent fat, 30 percent protein, and 40 percent carbohydrate which is a balanced nutritional basis for optimum overall diet.

### Example 2

### Skim Milk Cheese

### (Modification Using Non Fat Milk Powder)

| | 1000 lbs. |
|---|---|
| Non Fat Dry Milk | 66.20 |
| Salt | 20.4 |
| Tri Potassium Phosphate | 12.0 |
| 750 XLF | 3.6 |
| Water (cooltad) | 302.0 |
| | 1000.0 |

| | | | Method | Test |
|---|---|---|---|---|
| Analyte | Results | Units | Reference | Date Loc. |
| Ash | 8.71 | % | AOAC 935.42 | May 20, 2010 |
| Calories by | 253 | Cal/100 g | Atwater | May 24, 2010 |
| Calculation | | | Factors | |
| Carbohydrates | 33.03 | % | Calculation | May 24, 2010 |
| Calculation | | | | |
| Fat Mojo, Acid | 2.79 | % | AOAC 933.05 | May 20, 2010 |
| Hydrolysis | | | | |
| Moisture- | 31.53 | % | AOAC 926.08 | May 21, 2010 |
| Vacuum Oven | | | | |
| Protein-kjeldahl | | | AOAC 920.123 | May 24, 2010 |
| Protein Factor | 6.38 | — | | |
| As Received | 23.94 | % | | |

The present whole milk cheese of this invention is as follows:

### Example 3

### Imitation of Cheese

(Modification Using Non Fat Dry Milk with Fat Raised to Level of Whole Milk Powder Using Soybean Oil)

| | 1000 lbs |
|---|---|
| Non Fat Milk Powder | 474.2 |
| Soybean Salad Oil | 184.8 |
| (mix well) | |
| Salt | 20.4 |
| Tri Potassium Phosphate | 12.0 |
| 750 XLF | 3.6 |
| Water (cool to add) | 302.0 |
| | 1000.0 |

If you look at the dry weigh basis you can see the characteristics of a cheese being very close to the ideal nutritional levels.

As noted in FIG. 1, the various equipment utilized in the process for manufacturing whole milk cheese is shown therein. As noted, the entire system 1 generally includes a conveyer to for conveying the various ingredients to the mixing chamber, within a steam jacket, as at 3, which in this case is a twin screw mixer 2, as noted. It is in the mixing chamber where all the various ingredients, including the dry whole milk solids, and the flavoring components, the salt, tri sodium phosphate, chymosin, and rennet, are thoroughly mixed together, under detailed quality controlled conditions. Within the mixer, the water, which has reached the boiling stage, is at the hot water tank 4, is pumped into the various dry ingredients, within the mixer, to give the composition its liquefied and flowable state. At this stage, all of the mixed ingredients are deposited within a variety of cheese packages, and removed from the system by way of its conveyor 5. Within the conveyor, the processed cheese is packaged as at 6, for marketing. This is the process, and the apparatus, for use in the method for manufacturing a whole milk cheese.

Variations or modifications to the subject matter of this invention may occur to those skilled in the art upon review of the disclosure as provided herein. Such variations, if within the spirit of this invention, are intended to be encompass within the scope of any claims to patent protection. The description of the preferred embodiment, and the depiction of the process in the drawing, is primarily set forth for illustrative purposes only.

1. A cheese product manufactured as whole milk cheese, wherein the whole milk is the primary ingredient, and is maintained at a ph of approximately 6, such as salt and tri-potassium phosphate, are mixed with the dry whole milk, and then water is added within a stem jacket containing a mixture to provide a whole milk cheese for packaging and marketing.

2. The cheese product of claim 1, wherein heated water is added to the whole milk mixture to provide for the formation of the whole milk cheese at the moisture content desired for the finished cheese product.

3. The cheese product of claim 2 wherein the dry whole milk, salt, and the tri-sodium phosphate are mixed together as a dry thick homogenous mass, and then adding the heated water into the mass, and mixing the same, and then packaging the mixture into a whole milk cheese product for marketing.
